(19) United States
(12) Patent Application Publication
(10) Pub. No.: US 2024/0411121 A1
(43) Pub. Date: Dec. 12, 2024

(54) SINGLE POINT SENSING

(71) Applicant: Hewlett-Packard Development Company, L.P., Spring, TX (US)

(72) Inventors: Yang Lei, Palo Alto, CA (US); Fausto D'APUZZO, Palo Alto, CA (US)

(73) Assignee: Hewlett-Packard Development Company, L.P., Spring, TX (US)

(21) Appl. No.: 18/273,967

(22) PCT Filed: Jan. 25, 2021
(86) PCT No.: PCT/US2021/014959

§ 371 Date: Jul. 24, 2023

(51) Int. Cl. G02B 21/26; G05B 19/4155

(52) U.S. Cl. CPC G02B 21/26; G05B 19/4155; G05B 2219/49056

(57) ABSTRACT

A single point sensing system may include a microscope having a field of view, a single-point sensor having a focal point, a stage to support a substance, an actuator to move at least one of the single-point sensor and the stage relative to one another, and in alignment controller. The alignment controller is to identify a location of the substance on the stage based upon signals from the microscope and output sensor alignment signals to the actuator to align the location of the substance on the stage with the focal point of the single-point sensor based upon the identified location of the substance.

### BACKGROUND

Optical fluid interrogation or optical sensing may be used in a variety of applications to identify and analyze fluid compositions, to evaluate material placement by fluid dispensing, and to monitor or evaluate chemical and biological reactions and processes.

### BRIEF DESCRIPTION OF THE DRAWINGS

FIG. 1 is a diagram schematically illustrating portions of an example single-point sensing system during positioning of an example stage supporting an example substance within a field of view of a microscope.

FIG. 2 is a diagram schematically illustrating portions of the example single-point sensing system of FIG. 1 during alignment of the example substance on the stage with a focal point of a single-point sensor.

FIG. 3 is a flow diagram of an example single-point sensing method.

FIG. 4 is a diagram schematically illustrating portions of an example single-point sensing system during dispensing of an example substance onto an example stage.

FIG. 5 is a diagram schematically illustrating portions of the example single-point sensing system of FIG. 4 during positioning of the example stage supporting the example substance within a field of view of a microscope.

FIG. 6 is a diagram schematically illustrating portions of the example single-point sensing system of FIG. 4 during alignment of the example substance on the stage with a focal point of a single-point sensor.

FIG. 7 is a flow diagram of an example single-point sensing method.

FIG. 8 is a diagram semantically illustrating portions of an example single-point sensing system.

FIG. 9 is a block diagram schematically illustrating portions of an example non-transitory computer-readable medium containing instructions for the single-point sensing system of FIG. 8.

FIG. 10 is a diagram schematically illustrating an example single-point sensing method.

FIG. 11 is a diagram's schematically illustrating an example single-point sensing method.

FIG. 12A is a diagram of an example microscope captured image of a portion of an example substrate with highlighting of identified droplets from a first round of fluid droplet dispensing.

FIG. 12B is a diagram of an example microscope captured image of the portion of the example substrate with highlighting of identified droplets from a second round of fluid droplet dispensing.

FIG. 12C is a diagram of an example microscope captured image of the portion of the example substrate with highlighting of identified droplets from a third round of fluid droplet dispensing.

FIG. 12D is a diagram of an example microscope captured image of the portion of the example substrate with highlighting of identified droplets from a fourth round of fluid droplet dispensing.

Throughout the drawings, identical reference numbers designate similar, but not necessarily identical, elements. The figures, are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example single point sensing systems, methods and computer-readable mediums that facilitate optical sensing with smaller fluid volumes and/or a denser arrangement of optical interrogation sites upon a substrate to reduce the consumption of fluid and the substrate upon which the fluid is deposited for interrogation. Single-point sensors, sometimes referred to as optical readers, are sometimes used to interrogate the optical, chemical, or electrical properties of a fluid, the chemical reaction caused by the fluid on a substrate, or the fluid's dried solute on the substrate. For purposes of this disclosure, the fluid or its dried solute are both referred to as the “substance”. As compared to their imaging-capable counterparts, single-point sensors or single-point optical readers may be compact and inexpensive while providing high spatial resolution. Such single-point sensors may measure quantity such as fluorescence at different wavelengths, Raman spectra or infrared (IR) spectra.

Due to the extremely small focal point of single-point sensors, alignment of the focal point of a single-point sensor with the substance typically involves scanning the single-point sensor to locate the deposited substance, providing an array of multiple single-point sensors with the hope that one of the single-point sensors will align with the deposited substance, or depositing a relatively large area of substance on the substrate. Each of the above techniques may be problematic. Scanning the single-point sensor to locate the deposited substance may be slow and imprecise. Providing an array of multiple single-point sensors may increase both the cost and size of the sensing system. Depositing a relatively large area of substance on the substrate may consume a large amount of the substance or may consume a large amount of substrate. In some cases, the available amount of substance deposited as a fluid, such as a biological fluid sample, and/or the available amount of the substrate, such as a biopsy, may be limited.

The example single-point sensing systems, methods and computer-readable mediums utilize a microscope to identify a location of a substance on a stage and then use the identified location to align the location of the substance on the stage with a focal point of a single-point sensor. As a result, a small amount of the substance, resulting from a single fluid droplet containing the substance or a reduced number of such droplets, deposited upon a small region of a substrate, may be quickly and precisely aligned with the focal point of the single-point sensor and may be quickly and precisely interrogated or sensed. Because the location of each dispensed fluid droplet may be precisely identified, a dense array of individual fluid droplets may be deposited upon a very small area of substrate. As a result, a large number of individual substances may be densely deposited on a smaller size substrate and individually interrogated by the single-point sensor in circumstances where substrate availability is limited.

In some implementations, the larger denser array of individual fluid droplets, facilitated by the described single-point sensing systems, methods and computer readable mediums, facilitate multiple distinct tests or interrogations on a smaller size substrate. The dense array of individual fluid droplets may comprise multiple deposited substances of different chemical compositions, different concentrations, and/or different amounts. For example, droplets at different locations in the array may have different concentrations of a chemical substance being interrogated. In some implementations, multiple droplets may be dispensed at the same location, wherein the number of droplets at each location may be varied to control the concentration of a chemical composition being interrogated.

In some implementations, different regions of the substrate (interrogation sites), upon which the different fluid droplets are deposited, may also be varied to provide additional distinct tests. For example, the characteristics of a particular interrogation site may vary with respect to other interrogation sites in chemical composition or texture. In some implementations, the multiple interrogation sites may also vary from one another in the lapse of time between the deposition of the substance at the individual interrogation site and the sensing or interrogation of the interrogation site. In some implementations, the multiple interrogation sites may also vary from one another in the application of an external stimulus to the individual interrogation sites. For example, the application of external stimulus (heat, light, electrical charge, and the like) to the individual interrogation sites may be varied from one interrogation site to another. In some implementations, fluid droplets of different chemical composition, concentration or the like may be dispensed onto different interrogation sites having different chemical compositions and/or textures. As a result, a large variety of different tests may be carried out on a small substrate by (a) varying the characteristics of the fluid droplets being dispensed onto different interrogation sites, (b) by varying the characteristics of the different interrogation sites onto which the fluid droplets are dispensed and/or (c) by varying the type, duration, frequency, intensity or other characteristics of an external stimulus applied to the different interrogation sites of the dense array.

In some implementations, the alignment of the substance and the single-point sensor is automated. For example, a stage directly or indirectly supporting the substance may be located within a field of view of the microscope, wherein images captured by the microscope are used to identify the location of the substance on the stage. Using the identified location of the substance on the stage and a predetermined relative positioning of the focal point of the single-point sensor, a controller may output control signals that cause an actuator to move the stage and/or the single-point sensor relative to one another until the focal point of the single-point sensor is brought into alignment with the identified location of the substance on the stage. Because the field of view of the microscope is larger than the focal point of the single-point sensor, the positioning of the stage relative to the microscope to locate the substance on the stage within the field of view may not demand the same degree of preciseness as demanded to align the substance with a single focal point of the single-point sensor.

In some implementations, an initial location of the substance on the stage may be estimated based upon deposition of the substance onto the stage itself. For example, the controller may determine or estimate a location of a deposition site of the substance on the stage based upon characteristics and operation of a fluid droplet dispenser and the stage. Once the controller determines or estimates the location of the deposition site of the substance on the stage (directly on the stage or on a substrate supported by the stage), the controller may output microscope alignment signals to an actuator to locate the deposition site within the field of view of the microscope. Following imaging by the microscope and a more precise identification of the location of the substance on the stage, the controller may then output sensor alignment signals to align the precisely determined location of the substance on the stage with the single focal point of the single-point sensor.

In essence, such a system carries out an automated incremental two-stage substance location identification process. During the first stage, the general area of the stage containing the deposited substance (having a first degree of precision) is determined by the controller based upon the characteristics of the operation of the fluid droplet dispenser and the stage. In some implementations, the controller may also control operation of the fluid droplet dispenser. The controller then controls an actuator to position the determined general area containing the deposited substance within the field-of-view of the microscope. Once in position, the controller may actuate the microscope to capture an image of the general area of the stage supporting the deposited substance. The controller may then use the image of the general area captured by the microscope to identify the specific, more precise location of the substance on the stage. The specific location of the substance on the stage has a second degree of precision greater than the first degree of precision. The controller then uses the identified specific location of the substance on the stage to align the substance with the single focal point of the single point sensor.

In some example implementations, the single-point sensing system may be utilized to interrogate a combination of two substances deposited as two individual fluid droplets onto a stage, directly onto the stage or onto a substrate supported by the stage. In such example implementations, using the determination or identification of the specific location of the substance on the stage using the image captured by the microscope, the controller may also output control signals precisely aligning the specific location of the substance on the stage with a fluid droplet dispenser such that dispensing of a secondary fluid droplet by the fluid droplet dispenser will be precisely deposited onto the previously deposited substance. Thereafter, the controller may once again utilize the identified specific location of the substance on the stage to output control signals causing the actuator to align the specific location of the substance on the stage, also corresponding to the specific location of the subsequently dispensed secondary fluid droplet, with the single focal point of the single-point sensor.

In some implementations, the example single-point sensing systems, methods and computer-readable mediums may be utilized for combinatorial studies of conductive inks such as graphene platelets, carbon nanotubes, two-dimensional material suspensions and the like. For example, the example systems, methods, and mediums may facilitate the systematic study of micro deposition of conductive inks, their mixture and layering by facilitating precise positioning of electrical probes (provided by the single-point sensor) to measure surface conductivity with a two or four point/probe method, as well as other characteristics such as photo currents (by illuminating a spot with light) or other electrical properties such as energy, Hall effect and so on.

Disclosed is an example single point sensing system. The example single point sensing system may include a microscope having a field of view, a single-point sensor having a focal point, a stage to support a substance, an actuator to move at least one of the single-point sensor and the stage relative to one another, and in alignment controller. The alignment controller is to identify a location of the substance on the stage based upon signals from the microscope and output sensor alignment signals to the actuator to align the location of the substance on the stage with the focal point of the single-point sensor based upon the identified location of the substance.

Disclosed is an example single point sensing method. The method may comprise identifying a location of a substance on a stage based upon signals from a microscope and outputting sensor alignment signals to an actuator to align the location of the substance on the stage with a focal point of the single-point sensor based upon the identified location of the substance.

Disclosed is an example non-transitory computer-readable medium containing single-point sensing instructions to direct a processor. The instructions may comprise location identification instructions to direct the processor to identify a location of a substance on a stage based upon signals received from a microscope and sensor alignment instructions to direct the processor to output sensor alignment signals to the actuator to align the location of the substance on the stage with the focal point of the single-point sensor based upon the identified location of the substance.

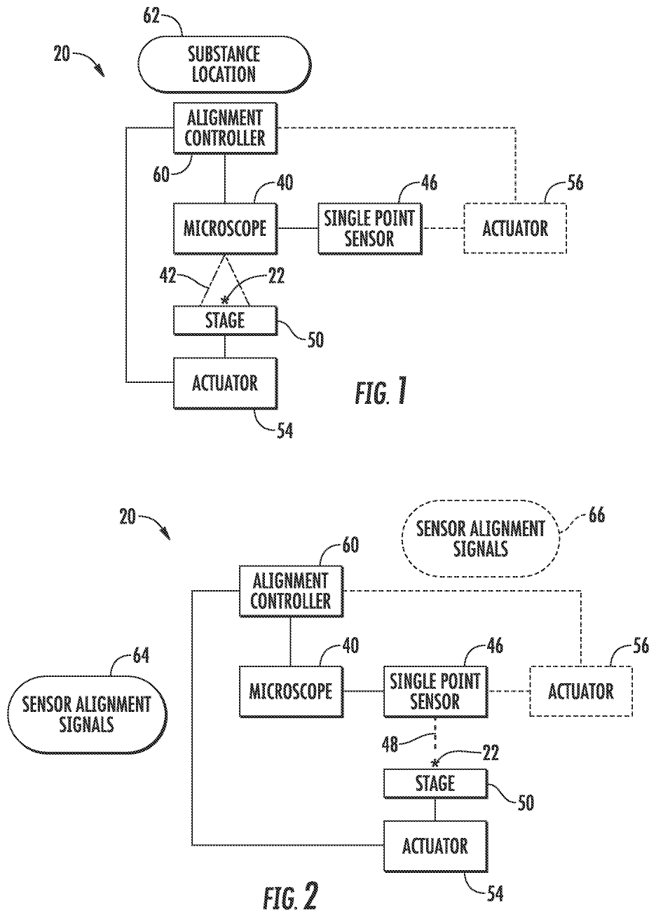

FIGS. 1 and 2 are block diagrams schematically illustrating an example single-point sensing system 20 during the sensing/interrogation of a substance 22. System 20 facilitates optical fluid sensing with smaller fluid volumes and/or a denser arrangement of optical interrogation sites upon a substrate to reduce the consumption of fluid and the substrate upon which the fluid is deposited for interrogation. System 20 comprises microscope 40, single-point sensor 46, stage 50, actuator 54 and alignment controller 60.

Microscope 40 comprises an instrument, such as a light microscope or an electron microscope, having a field-of-view 42 (shown in FIG. 1). Microscope 40 captures or generates images of objects within its field-of-view 42. In some implementations, microscope 40 transmits electrical signals based upon objects within the field-of-view 42, wherein the electrical signals may be utilized to generate images of what appears in the field-of-view. In some implementations, microscope 40 has a field-of-view between 0.5 and 5 mm with a magnification of at least 1× and an image resolution of at least 10 microns. In other implementations, microscope 40 may have other characteristics.

Single-point sensor 46 comprises an optical reading device having a single optical axis or focal point 48 (shown in FIG. 2). In some implementations, single focal point 48 has a diameter of 1 micron and no greater than 250 microns. Examples of single-point sensor 46 include, but are not limited to, a spectrometer, a Raman spectrometer, UV/VIS spectrometer, a colorimeter, a fluorimeter, a non-linear spectrometer, and an ultrafast laser spectrometer. Single-point sensor 46 may have a fixed positional relationship to microscope 40.

Stage 50 comprises a support surface upon which substance 22 may directly or indirectly rest as substance 22 is positioned within field-of-view 42 of microscope 40 or in alignment with focal point 48 of single-point sensor 46. In some implementations, stage 50 may support a substrate upon which substance 22 is formed or deposited. For example, in some implementation, stage 50 may support a tissue sample or biopsy. In some implementations, stage 50 may support a transparent slide upon which substance 22 rests. In some implementations, stage 50 is movable relative to microscope 40 and single-point sensor 46. In some implementations, stage 50 is movable in three orthogonal axes relative to microscope 40 and single-point sensor 46 so as to provide three-dimensional positioning of stage 50 and substance 22.

Actuator 54 comprises a device operably coupled to stage 50 to move stage 50 relative to microscope 40 and single-point sensor 46. Actuator 54 may utilize electrical power to drive an electric solenoid, an electric motor with an associated mechanical transmission, a pneumatic pump or the like so as to move stage 50. As shown by broken lines, in some implementation, system 20 may additionally comprise a secondary actuator 56, similar to actuator 54, but operably coupled to microscope 40 and single-point sensor 46 to controllably move microscope 40 and single-point sensor 46 relative to stage 50. In such an implementation, the positioning of substance 22 with respect to the field-of-view 42 and the focal point 48 may be achieved using both of actuators 54 and 56. In some implementations, actuator 54 may be omitted where the positioning of stage 50 relative to the field of view 42 of microscope 40 and the focal point 48 of single-point sensor 46 is achieved using actuator 56 to move microscope 40 and single-point sensor 46 while stage 50 remains stationary.

Alignment controller 60 comprises a processing unit which follows instructions contained in a non-transitory computer-readable medium to align substance 22 with focal point 48 to facilitate sensing by single-point sensor 46. As shown by FIG. 1, alignment controller 60 receives signals from microscope 40 that are generated by microscope 40 while substance 22 is within the field-of-view 42 of microscope 40. Alignment controller 60 utilizes signals to distinguish substance 22 on stage 50 from the surface of stage 50 and/or other non-substance surfaces or materials on stage 50. Alignment controller 60 further identifies a specific, precise location 62 of the substance 22 on stage 50 based upon such signals from microscope 40. For example, alignment controller 60 may employ optical recognition to identify the precise coordinates of substance 22 on stage 50.

As shown by FIG. 2, alignment controller 60 uses the identified specific or precise location of substance 22 on stage 50 to generate and output control signals, sensor alignment signals 64, which are transmitted to actuator 54, causing actuator 54 to move stage 50 relative to single-point sensor 46 so as to align the specific location of substance 22 on stage 50 with the focal point 48 of single-point sensor 46. As indicated by broken lines, in some implementations where actuator 56 is provided as part of system 20, alignment controller 60 may additionally or alternatively use the identified specific or precise location of substance 22 on stage 50 to generate and output control signals, sensor alignment signals 66, which are transmitted to actuator 56, causing actuator 56 to move single-point sensor 46 relative to stage 50 so as to align the specific location of substance 22 on stage 50 with the focal point 48 of single-point sensor 46. As discussed above, in some implementations, actuator 54 may be omitted in favor of actuator 56. In such implementations, the alignment of substance 22 with focal point 48 may be achieved by alignment controller 60 controlling the positioning of stage 50 with actuator 56.

Upon alignment of substance 22 with the focal point 48 of single-point sensor 46, single-point sensor 46 may be actuated to sense or interrogate substance 22 and/or the interaction between substance 22 and any substrate, such as a tissue sample or biopsy, supporting substance 22. In some implementations, alignment controller 60 may further control the operation of single-point sensor 46. For example, once substance 22 has been aligned with focal point 48, alignment controller 60 may automatically output signals to single-point sensor 46 to initiate the sensing or interrogation of substance 22 (such as its chemical composition, electrical properties, its positioning, its size, or the like) or interactions caused by substance 22 (such as interaction with other chemicals or materials also supported by stage 50).

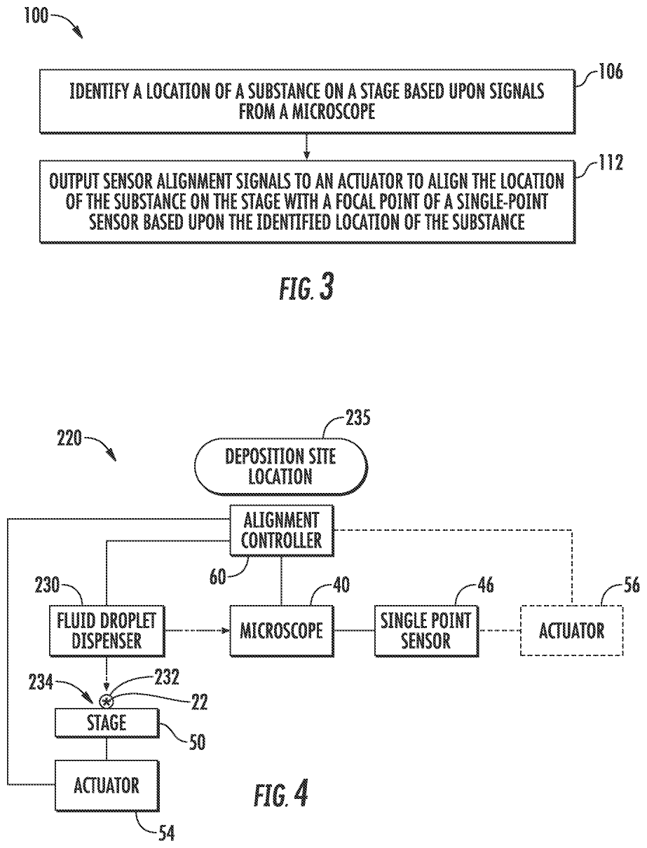

FIG. 3 is a flow diagram of an example single-point sensing method 100. Method 100 utilizes a microscope to identify a location of a substance on a stage and then use the identified location to align the location of the substance on the stage with a focal point of a single-point sensor. As a result, a small amount of the substance, resulting from a single fluid droplet containing the substance or a reduced number of such droplets, deposited upon a small region of a substrate may be quickly and precisely aligned with the focal point of the single-point sensor and may be quickly and precisely interrogated or sensed. Although method 100 is described in the context of being carried out by system 20, it should be appreciated that method 100 may likewise be carried out with other similar systems.

As indicated by block 106, the location of a substance 22 on a stage 50 is identified based upon signals from microscope, such as microscope 40. In system 20, alignment controller 60 identifies the location of the substance 22. Such identification may involve optical feature recognition, wherein substance 22 may have a predetermined optical characteristic that is distinct from the optical characteristics of the underlying stage 50 and/or substrate and wherein alignment controller 60 uses this predetermined optical characteristic to distinguish substance 22 from its surroundings on stage 50. By distinguishing substance 22 from its surroundings, alignment controller 60 may identify the precise dimensions, shape, and location of substance 22. For example, in some implementations, substance 22 may have a predetermined light absorption characteristic where substance 22 appears darker as compared to stage 50 or any substrate upon stage 50 supporting substance 22. Alignment controller 60 may identify those regions of the captured image of the field-of-view 42 of microscope 40 that are darker, wherein such darker regions may be identified as substance 22. Once the substance 22 has been identified, its relative precise location may be determined based upon the positioning of stage 50 relative to microscope 40 during the image capture and the location of substance 22 relative to stage 50 or relative to the bounds of the field-of-view 42 of microscope 40.

As indicated by block 112, upon determining the precise location of substance 22, alignment controller 60 may output sensor alignment signals to an actuator (actuator 54 and/or actuator 56) to align the location of substance 22 on stage 50 with the focal point 48 of single-point sensor 46. Thereafter, single-point sensor 46 may be actuated to sensor interrogate substance 22 and/or any reaction caused by substance 22 or changes in substance 22.

FIGS. 4-6 are block diagrams schematically illustrating single-point sensing system 220 during the sensing of substance 22. FIG. 4-6 illustrate an example of how substance 22 may additionally be dispensed and located within the field-of-view 42 of microscope 40 prior to being aligned with focal point 48 of single-point sensor 46 using signals from microscope 40. System 220 is similar to system 20 described above except that system 220 additionally comprises fluid droplet dispenser 230. Those remaining components of system 220 which correspond to components of system 20 are numbered similarly.

Fluid droplet dispenser 230 comprises a device that selectively or controllably dispenses fluid droplets. In some implementations, fluid droplet dispenser 230 dispenses micro droplets, each micro droplet having a pico-liter range with a volume of no greater than 100 pl. Fluid droplet dispenser 230 may be fluidically connected to a fluid source or multiple distinct fluid sources that supply a single type of fluid or multiple types of fluid for dispensing. In some implementations, fluid droplet dispenser 230 comprises a fluid actuator that displaces fluid through a nozzle to reject a droplet of fluid. Examples of such a fluid actuator include, but are not limited to, a piezo-membrane based actuator, an electrostatic membrane actuator, a thermal resistive fluid actuator, a mechanical/impact driven membrane actuator, a magneto-strictive drive actuator, an electrochemical actuator, and external laser actuators (that form a bubble through boiling with a laser beam), other such microdevices, or any combination thereof.

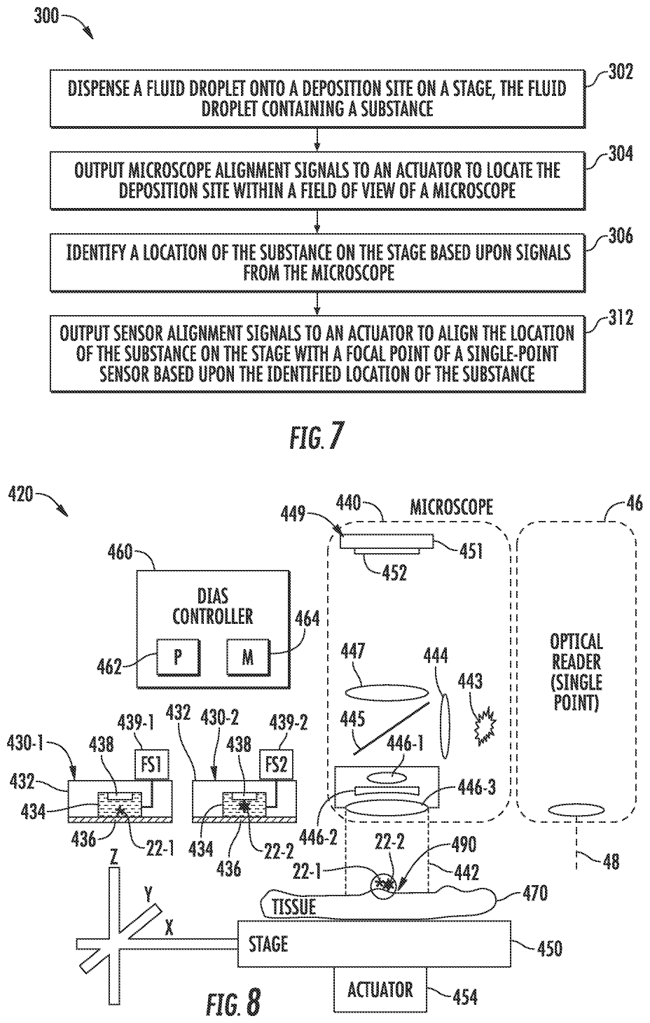

FIG. 7 is a flow diagram of an example single-point sensing method 300 that may be carried out by single-point sensing system 200. As indicated by block 302 and shown in FIG. 4, fluid droplet dispenser 230 may dispense a fluid droplet 232 containing substance 22 onto a deposition site 234 on stage 50. In the example illustrated, fluid droplet dispenser 230 dispenses fluid droplet 232 in response to fluid droplet dispensing signals received from alignment controller 60. Based upon characteristics of the fluid droplet dispenser 230, the particular dispensing characteristics of the fluid droplet and the positioning of stage 50 during such dispensing, alignment controller 60 may determine or estimate the deposition site location 234. For example, alignment controller 60 may estimate the general deposition site location 234 based upon factors such as the vertical spacing between fluid droplet dispenser 230 and stage 50, the relative horizontal positioning of stage 50 relative to fluid droplet dispenser 230, the force at which a fluid droplet is ejected by fluid droplet dispenser 230, the volume and/or mass of the fluid droplet being ejected and the like. Such location may have a first degree of precision and/or accuracy generally insufficient for precise alignment with the focal point 48 of the single-point sensor 46. In some implementations, the single droplet has a maximum width of no greater than 500 microns at the deposition site. In some implementations, the substance 22 is contained in a sample mass on the stage or substrate having a diameter of no greater than 2 mm.

As indicated by block 304 in FIG. 7 and shown in FIG. 5, alignment controller uses the determined or estimated deposition site location 234 to output microscope alignment signals 238 to actuator 54. The microscope alignment signals 238 cause actuator 54 to move stage 50 so as to locate the deposition site location 234 within the field-of-view 42 of microscope 40. As shown by broken lines in FIG. 5, in some implementations where actuator 56 is provided as part of system 220, alignment controller 60 may additionally or alternatively use the deposition site location 234 on stage 50 to generate and output control signals, microscope alignment signals 239, which are transmitted to actuator 56, causing actuator 56 to move microscope 40 relative to stage 50 so as to locate the deposition site location 234 on stage 50 with the field-of-view 42 of microscope 40. As discussed above, in some implementations, actuator 54 may be omitted in favor of actuator 56. In such implementations, the positioning of the estimated deposition site location 234 within the field-of-view 42 of microscope 40 may be achieved by alignment controller 60 controlling the positioning of stage 50 with actuator 56.

As indicated by block 306 and FIG. 7, once the deposition site location 234 has been located within the field-of-view 42 microscope 40, resulting in the substance 22 also being located within the field-of-view 42 of microscope 40, alignment controller 60 may output signals actuating microscope 40, causing microscope 40 to capture an image of the field-of-view 42. As described above with respect to block 106 of method 100, based upon signals received from microscope 40 representing the captured image, alignment controller 60 may identify a precise substance location 62 of substance 22. The precise substance location 62 has a second degree of precision and/or accuracy that is greater than the first degree of precision and/or accuracy. The second degree of precision and/or accuracy is sufficient for alignment with the focal point 48 of single-point sensor 46. In some implementations, the second degree of precision and/or accuracy is 90% or more and, in some implementations, more than 95%.

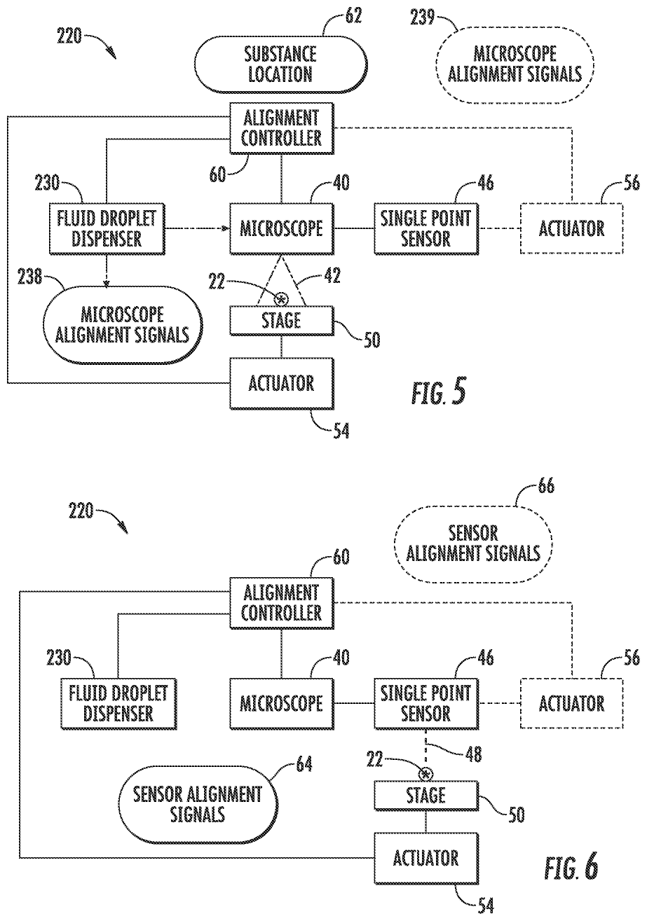

As indicated by block 312 in FIG. 7 and shown in FIG. 6, based upon the identified substance location 62, derived from the signals from microscope 40, alignment controller 60 outputs sensor alignment signals 64 to actuator 54 to align the precise location of substance 22 on stage 50 with the focal point 48 of single-point sensor 46. As indicated by broken lines, in some implementations where actuator 56 is provided as part of system 20, alignment controller 60 may additionally or alternatively use the identified specific or precise location of substance 22 on stage 50 to generate and output control signals, sensor alignment signals 66, which are transmitted to actuator 56, causing actuator 56 to move single-point sensor 46 relative to stage 50 so as to align the specific location of substance 22 on stage 50 with the focal point 48 of single-point sensor 46. As discussed above, in some implementations, actuator 54 may be omitted in favor of actuator 56. In such implementations, the alignment of substance 22 with focal point 48 may be achieved by alignment controller 60 controlling the positioning of stage 50 with actuator 56.

FIG. 8 is a diagram schematically illustrating portions of an example single-point sensing system 420. FIG. 8 illustrates an example microscope, an example stage and actuator, an example alignment controller, and an example set of fluid droplet dispensers. FIG. 8 further illustrates an example of how multiple fluid droplet may be precisely co-located on a stage, or on a substrate supported by the stage, using a single-point sensing system such as single-point sensing system 420. Single-point sensing system 420 comprises fluid droplet dispensers 430-1, 430-2 (collectively referred to as dispensers 430), microscope 440, single-point sensor 46, stage 450, actuator 454, and dispensing, imaging, alignment, and sensing (DIAS) controller 460.

Fluid droplet dispensers 430 are each similar to fluid droplet dispenser 230 described above in that each of fluid droplet dispensers 430 are to controllably dispense reject droplets of fluid onto a stage or a substrate supported by a stage. In the example illustrated, each of fluid droplet dispensers 430 comprises a chamber layer 432 forming or providing an ejection chamber 434, an ejection nozzle or orifice 436 and a fluid actuator 438. In some implementations, chamber layer 432 may comprise a photo-imageable epoxy, such as SU8, in which ejection chamber 434 is formed. In other implementations, chamber layer 432 may be formed from other materials. Ejection orifice 436 comprises an opening in communication with ejection chamber 434 and through which droplets of fluid are dispensed.

Fluid actuator 438 comprises a device that is to displace fluid within fluid ejection chamber 434 causing droplets of fluid to be dispensed through ejection orifice 436. Examples of such a fluid actuator 438 include, but are not limited to, a piezo-membrane based actuator, an electrostatic membrane actuator, a thermal resistive fluid actuator, a mechanical/impact driven membrane actuator, a magneto-strictive drive actuator, an electrochemical actuator, and external laser actuators (that form a bubble through boiling with a laser beam), other such microdevices, or any combination thereof.

In some implementations, fluid droplet dispensers 430 are formed as part of a single fluidic die or fluid ejection head. In other implementations, fluid droplet dispensers 430 may be provided part of separate or distinct fluidic dies or fluid ejection heads. In yet other implementations, fluid droplet dispensers 430 may have other constructions for the control and selective dispensing of individual fluid droplets onto stage 450 or a substrate supported by stage 450.

As further shown by FIG. 8, fluid droplet dispensers 430-1 and 430-2 are fluidly connected to different fluid supplies, fluid supply 439-1 and 439-2 (collectively referred to as fluid supplies 439), respectively. Fluid may be delivered from fluid supplies 439 to ejection chambers 434 of fluid droplet dispensers 430 using pumps, such as inertial pumps, gravity, or the like. Fluid supplies 439 supply different fluids having different characteristics. For example, fluid supply 439-1 supplies substance 22-1 while fluid supply 439-2 supplies substance 22-2. Substances 22-1 and 22-2 may have different chemical compositions. In some implementations, substances 22-1 and 22-2 may be suspended within different solutions or fluid. In some implementations, substance 22-1, 22-2 may be themselves in the form of different fluids. Although system 420 is illustrated as comprising two different fluid droplet dispensers 430 with two associated different fluid supplies 439, in other implementations, system 420 may include additional fluid droplet dispensers and additional fluid supplies.

Microscope 440 is similar to microscope 40 described above in that microscope 440 images a field-of-view 442 of stage 450 or a substrate supported by stage 450. In the example illustrated, microscope 440 comprises a light source 443, lens 444, partially reflective, partially transmissive mirror 445, viewing lenses 446-1, 446-2, 446-3 (collectively referred to as viewing lenses 446), focal lens 447 and imager 449. Light source 443 may comprise an ambient light source directing light from the outside environment or may comprise a power light source such as a light emitting diode or set of diodes. Lens 444 directs light from light source 443 towards mirror 445 which reflects such light through viewing lenses 446 toward stage 450. Light reflected from stage 450 and/or any substrate supported by stage 450 (within the field-of-view 442) is directed back through viewing lenses 446, through mirror 445. Focal lens 447 directs the reflected light towards imager 449.

Imager 449 outputs electrical signals based upon the light it receives. In some implementations, imager 449 may comprise a substrate 451 supporting charge coupled device (CCD array 452. In other implementations, imager 459 may comprise other types of electronic devices that optically sense light directed from stage 450 and/or a substrate supported by stage 450 and which output electrical signals or images based upon such sensing. In other implementations, microscope 440 may have other constructions.

Stage 450 is to support a substance or multiple substances (a) opposite to each of fluid droplet dispensers 430, (b) within the field-of-view 442 of microscope 440 and (c) in alignment with a single focal 48 of single-point sensor 46. In the example illustrated, stage 450 is movable in three axes, the illustrated x, y, and z axes. Stage 450 is to be moved by actuator 454 which is similar to actuator 54 described above. As described above with respect to system 220, in some implementations, stage 450 may be stationary, wherein an actuator such as actuator 56 or multiple actuators controllably move and position fluid droplet dispensers 430, microscope 440, and single-point sensor 446 opposite to stage 450.

DIAS controller 460 controls the dispensing of fluid droplets/substances 22 onto substrate 470, the positioning and imaging of substances 22 by microscope 440, the alignment of substances 22 with single-point sensor 46, and the sensing of substances 22 by single-point sensor 46. DIAS controller 460 comprises a processor 462 and non-transitory computer-readable medium 464. Processor 462 is to follow instruction contained in medium 464. Such instructions may be in the form of software code or may be in the form of physical logic components in a micro-chip or circuit. In the example illustrated, the instructions contained in medium 464 facilitate a selectable mode of operation wherein the different substances 22-1 and 22-2 may be precisely: located upon stage 450 or upon a substrate supported by stage 450 for being sensed by single-point sensor 46.

In the example illustrated, the different substances 22 are illustrated as being co-located upon a substrate 470 in the form of a biopsy or tissue. In other implementations, substrate 470 may comprise a transparent microscope slide, a well plate or other structure upon which substances 22 may be deposited. In some implementations, substrate 470 may comprise a circuit board or the like, wherein substances 22 comprise electrically conductive materials forming electrically conductive traces upon the substrate. In yet other implementations, substrate 470 may have other forms.

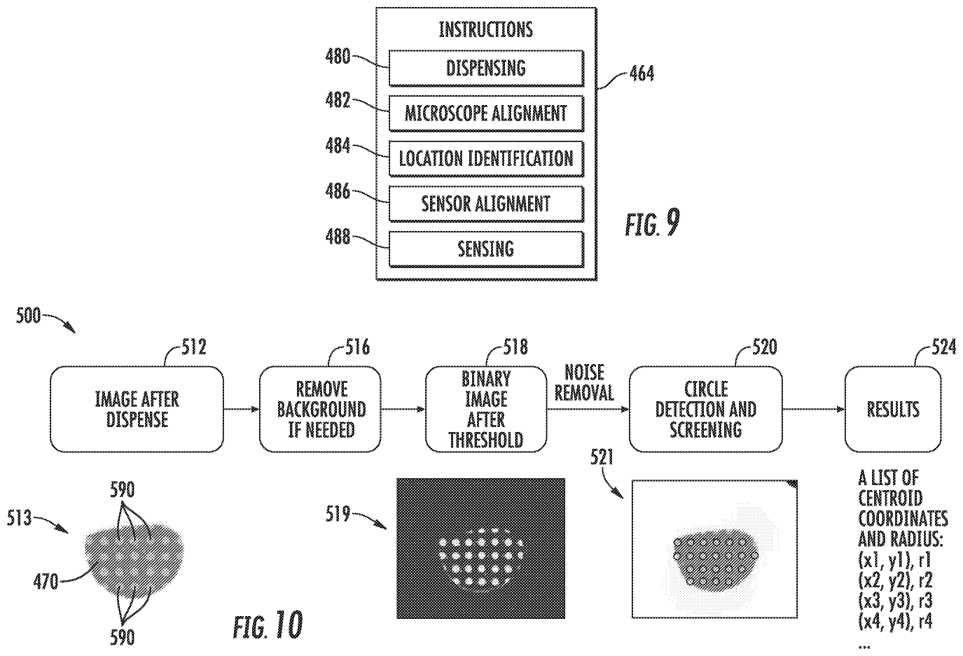

As shown by FIG. 9, the instructions contained on medium 464 comprise dispensing instructions 480, microscope alignment instructions 482, location identification instructions 484, sensor alignment instructions 486, and sensing instructions 488. Dispensing instructions 480 direct processor 462 to output control signals causing the dispensing of individual fluid droplets by fluid droplet dispensers 430. In some implementations, instructions 480 further output control signals to actuator 454 causing actuator 454 to move stage 450 in the x axis direction, the y-axis direction and/or the z axis direction to enhance control over the depositing of a fluid droplet onto stage 450 and/or substrate 470.

Microscope alignment instructions 482 direct processor 462 to output microscope alignment signals to actuator 454 to position a location of a deposition site of an individual fluid droplet within field-of-view 442 of microscope 440. Such control signals may cause actuator 454 to move stage 450 in the x axis direction, the y-axis direction and/or the z axis direction to enhance imaging of the dispensed substances 22-1 and/or 22-2. In some implementations, instructions 482 further direct processor 462 to estimate or determine the location of the deposition site for a deposited individual fluid droplet. The location of the deposition site may comprise the general area of the stage containing the deposited substance (having a first degree of precision) which is determined based upon the characteristics of the operation of the fluid droplet dispenser 430-1, 430-2 and the positioning of stage 450 relative to the fluid droplet dispenser 430-1, 430-2 during the dispensing of the droplet.

In some implementations, microscope alignment instructions 482 may initially output control signals causing actuator 454 to locate stage 450 and the supported substrate 470 opposite to microscope 440, within the field-of-view 442 of microscope 440, to image substrate 470 prior to the deposition of any fluid droplet or substance 22-1, 22-2 onto substrate 470. Such imaging may identify the size, shape, and thickness of substrate 470. Using such imaging, controller 460 may output control signals causing actuator 454 to locate substrate 470 relative to a one of fluid droplet dispensers 430 for enhanced control over the precise location of the deposition site on substrate 470 for substance 22-1 and/or substance 22-2.

Once microscope 440 has sensed or imaged the deposition site 490 of the first substance 22-1 deposited by fluid droplet dispenser 430-1, location identification instructions 484 may direct processor 462 to identify a more precise location of substance 22-1 (having a second greater degree of precision as to the initially determined deposition site for substance 22-1) based upon the imaging provided by microscope 440. In some implementations, location identification instructions 484 may direct processor 462 to identify and ignore background pixels in the image pixels by setting a threshold according to characteristics of the background and foreground such as brightness, color, roughness, and the like. Thereafter, instructions 44 may direct processor 462 to focus on the foreground and carry out image segmentation to identify candidate pixels of the deposited substance 22-1. Such segmentation may be carried out using image thresholding, machine learning based segmentation algorithms, such as U-Net. Connected component analysis on the segmentation image may further be carried out to remove noise. For example, if a particular component in the image is much smaller than the expected size of a droplet/substance 22-1, the component may be removed from the image.

Deposited droplets or dried fluid droplets providing substance 22-1 may have a circular shape. As a result, location identification instructions 484 may direct processor 462 to carry out various circular detection algorithms to analyze the binary image after noise removal to identify candidate individual droplet/substance 22-1. One example of such a circle detection algorithm is a Hough transformation.

In some implementations, the detection of the circle and the resulting detection of the more precise location of the fluid droplet/substance 22-1 on substrate 470 may be carried out using circle screening based upon two criteria: a Jaccard index and droplet size. Processor 462 utilizes the Jaccard index, also referred to as an intersection over union index, to compare any connected component and its corresponding circle in the image. Processor 462 uses the size criteria to compare the detected size of the circle in the image with the size of an expected droplet. If processor 462 determines that the intersection over their union is larger than a threshold (under the Jaccard index criteria) and if the detected circle approximates the size of an expected droplet (under the size criteria), processor 462 may equate the candidate droplet in the image and its location in the image to the precise location of the individual droplet/substance 22-1 for subsequent alignment with the axis 46 of single-point sensor 46.

Thereafter, dispensing instructions 480 may utilize the more precise location of substance 22-1 to direct processor 462 to output control signals to actuator 454 so as to cause actuator 454 to locate the more precise location of substance 22-1 opposite to fluid droplet dispenser 430-2 such that a fluid droplet ejected by fluid droplet dispenser 430-2, providing substance 22-2, will be precisely deposited and co-located with the previously deposited substance 22-1.

Sensor alignment instructions 486 direct processor 462 to output sensor alignment signals to actuator 454 to align the more precise location of co-located substances 22-1 and 22-2 on substrate 470, supported by stage 450, with the single focal point 48 of single-point sensor 46. In some modes of operation, a single substance 22-1 or 22-2 may be deposited and imaged by microscope 440 (without the dispensing of the other of the substances 22-1 or 22-2), wherein sensor alignment instructions 486 direct processor 462 to output sensor alignment signals to actuator 454 to align the more precise location of the single substance 22-1 or 22-2 with the single focus point 48 of single-point sensor 46.

For example, in some implementations, following the determination of the more precise location of the substance 22-1, 22-2 (based upon images from microscope 440), actuator 454 may be directed to move stage 450 by first amount (X1, Y1, Z1) that is equal to the distance between the axis of microscope 440 (the center of its field-of-view 442) and the focal point 48. Thereafter, actuator 454 may be directed to move stage 450 by a second amount (X2, Y2, Z2) that corresponds to a distance between the determined more precise location of the substance 22-1 and/or 22-2 and the optical axis of microscope 440 (and different focal planes due to substrate thickness which may be determined with an autofocus routine). As a result, system 420 may position each droplet or deposition site 490 in the optical focus or focal point 48 of single point sensor 46 with high accuracy (in some implementations, less than 10 μm) with reduced reliance on further signal optimization which may be slow. In some implementations, the field-of-view 442 has a diameter greater than the diameter of the focal point 48 of single-point sensor 46. In some implementations, microscope 440 has a field-of-view 442 having a diameter of 2 mm, whereas single focal point 48 has a diameter of 1 micron and no greater than 250 microns.

Once the co-located substances 22-1 and 22-2 are aligned with focal point 48 of single-point sensor 46 or once the individual substance 22-1 or 22-2 has been aligned with focal point 48 of single-point sensors 46, sensing instructions 488 direct processor 462 to output control signals actuating single-point sensor 46. Examples of single-point sensor 46 include, but are not limited to, a spectrometer, a Raman spectrometer, UV/VIS spectrometer, a colorimeter, a fluorimeter, a non-linear spectrometer, and an ultrafast laser spectrometer. Single-point sensor 46 may have a fixed positional relationship to microscope 440.

In some implementations, rather than co-locating different fluid droplets of different substances 22-1, 22-2 for interrogation, different fluid droplets of the same substance 22-1 or 22-2 or different fluid droplets of different substances 22-1, 22-2 may be deposited upon substrate 470 in a pattern for sensing by single-point sensor 46. Because such sensing is carried out by single-point sensor and because the precise location of the individual substances 22 are determined using data provided by microscope 440, multiple substance interrogation sites may be located upon substrate 470. As a result, a large number of individual substances may be sparsely deposited on a smaller size substrate 470 and individually interrogated by the single-point sensor 46 in circumstances where the size or availability of substrate 470 is limited. Because the distance between different interrogation sites is reduced, the compact arrangement of the multiple interrogation sites may further facilitate multiple interrogations in a shorter amount of time.

FIG. 10 is a diagram illustrating an example method 500 for facilitating the interrogation of multiple sparsely patterned interrogation sites, wherein the different interrogation sites include a deposited substance or multiple deposited substances of different chemical compositions and/or different amounts. In some implementations, the multiple interrogation sites may differ from one another in the characteristics of the substrate 470 that underlie each of the individual interrogation sites. For example, different portions of substrate 470 may have different chemical compositions, different textures, or other different characteristics, wherein the characteristics of a particular interrogation site may vary in the composition and/or volume of the substance as well as the chemical composition or other characteristics of the underlying region of substrate 470. In some implementations, the multiple interrogation sites may also vary from one another in the lapse of time since deposition of the substance at the individual interrogation site and/or the application of external stimulus (heat, light, and the like) to the individual interrogation sites. Although method 500 is described in the context of being carried out using system 420 described above, in other implementations, method 500 may likewise be carried out by system 220 or other similar systems.

As indicated by block 512 and depicted by the example image 503 taken by microscope 440, following the dispensing of substance 22-1 in a pattern at multiple deposition/interrogation sites 590 upon substrate 470, the multiple interrogation sites 590 are positioned within the field-of-view 442 of microscope 440 and imaged by microscope 440. In the example illustrated, microscope alignment instructions 482 direct processor 462 to position the sparse pattern of deposition/interrogation sites 590 within the field-of-view 442 of microscope 440.

As indicated by block 516, location identification instructions 484 direct processor 462 to remove any background from the image of the multiple interrogation sites 590. Such removal may be carried out by comparing an image of substrate 470 prior to the deposition of substance 22-1 at each of the interrogation sites 590 with the subsequent image of substrate 470 with the deposited substance 22-1 at each of the interrogation sites 590. In some implementations, the background may be removed by using a threshold according to characteristics of the background and foreground such as brightness, color, roughness, and the like.

As indicated by block 518 and depicted by the example image 519, location identification instructions 484 further direct processor 462 to generate a binary image of the interrogation sites 590. Instructions 484 direct processor 462 to carry out image segmentation to identify candidate pixels in the image that may correspond to individual droplets or spots of substance 22-1. In some implementations, image thresholding such as machine learning based segmentation algorithms may be used. In some implementations, a machine learning based segmentation algorithm such as U-Net, a convolutional neural network architecture, may be used by processor 462.

As indicated by block 520 and depicted by example image 521, location identification instructions 484 may direct processor 462 to carry out circle detection and screening. The example image 521 is an example of an image of a region of substrate 470 captured by microscope 440 with highlighting of the identified droplets/spots of substance 22-1, 22-2 following the circle detection and screening. Prior to such circle detection and screening, location identification instructions 484 may direct processor 462 to remove any noise from the image captured by microscope 440. During such noise removal, image components that are much smaller than the size of the droplet are removed.

Circle detection and screening is based on the premise that deposited droplets or dried fluid droplets providing substance 22-1 may have a circular shape. As a result, location identification instructions 484 may direct processor 462 to carry out various circular detection algorithms to analyze the binary image after noise removal to identify circles deemed to be the individual droplets of substance 22-1. One example of such a circle detection algorithm is a Hough transformation.

In some implementations, the identified circles are further screened using two criteria: a Jaccard index and droplet size. Processor 462 utilizes the Jaccard index, also referred to as an intersection over union index, to compare any connected component and its corresponding circle in the image. Processor 462 uses the size criteria to compare the detected size of the circle in the image with the size of an expected droplet. If processor 462 determines that the intersection over their union is larger than a threshold (under the Jaccard index criteria) and if the detected circle approximates the size of an expected droplet (under the size criteria), processor 462 may equate the candidate droplet in the image and its location in the image to the precise location of the individual droplet/substance 22-1 for subsequent alignment with the axis 48 of single-point sensor 46.

As indicated by block 524, location identification instructions 484 direct processor 462 to determine the centroid coordinates and radius of each of the identified circles, each of the identified droplets (spots of substance 22-1 and/or 22-2) on substrate 470 or, in some implementations, directly on stage 450. This may be done by processor 462 evaluating the relative location of the individual droplets in the image with respect to the field-of-view 442 of microscope 440 and the relative positioning of stage 450 with substrate 470. Thereafter, sensor alignment instructions 486 may direct processor 462 to utilize the centroid coordinates and radii of each of the identified circles to output control signals causing actuator 454 to sequentially locate or align each of the identified circles/spots of substance 22-1, 22-2 with optical axis or focal point 48 of single-point sensor 46 for individual sensing in accordance with sensing instructions 488.

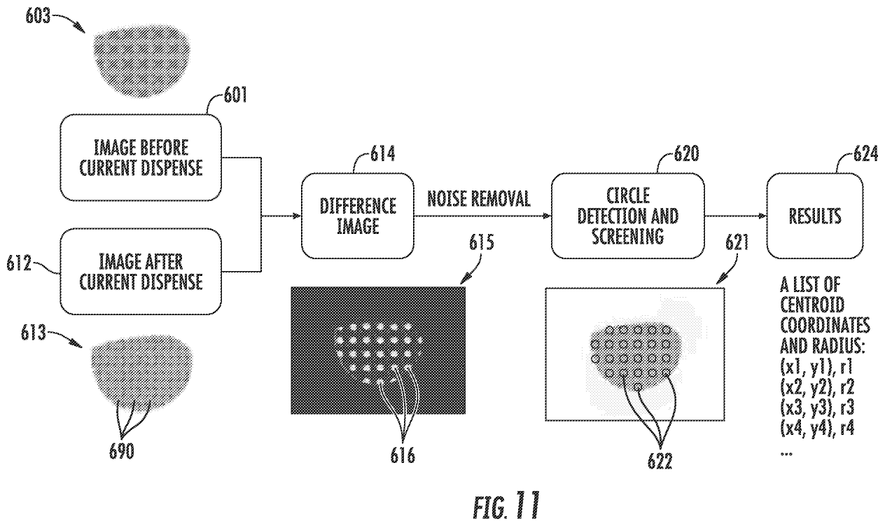

FIG. 11 is a diagram illustrating an example single-point sensing method 600 that may be carried out by system 420 or similar systems. FIG. 11 illustrates an example of how system 420 may be used to sense dense patterns of interrogation sites on a stage or substrate to provide even more interrogation sites in a smaller area. As indicated by block 601 and depicted by the example microscope captured image 603, prior to a current round of dispensing fluid droplets onto substrate 470 or onto stage 450, microscope alignment instructions 482 may direct processor 462 to position substrate 470 or stage 450 opposite to microscope 440, where substrate 470, with any prior round or rounds of fluid droplet dispensing, is imaged. Based upon the available regions of substrate 470 determined from the captured image 603, dispensing instructions 480 may direct processor 462 to determine or design a dispense pattern for the upcoming current dispensing of fluid droplets. Following determination of the dispense pattern, dispense instructions 480 may direct processor 462 to output control signals to actuator 454 and to one or both of fluid droplet dispensers 430 so as to dispense fluid droplets, providing substance 22-1 and/or 22-2, in accordance with the dispense pattern.

As indicated by block 612 and depicted by the example microscope captured image 613, microscope alignment instructions 482 direct processor 462 to position the dispensed pattern of interrogation sites at which individual droplets 690 were dispensed within the field of view 442 of microscope 440 (shown in FIG. 8). Thereafter, microscope 440 images those portions of substrate 470 within its field of view 442 to generate image 613 of substrate 470 with the dispensed pattern of fluid droplets 690. As indicated by block 614 and depicted by the example image 615, location identification instructions 484 may direct processor 462 to identify a difference between the image 603 captured by microscope 440 prior to the current dispensing round and the image 613 captured by microscope 440 following the current dispense round. The difference between images 603 and 613 (shown by the example image 615) may be segmented to identify candidate pixels of the individual droplets (spots of substances 22-1, 22-2) on substrate 470. As discussed above, in some implementations, image thresholding, such as machine learning based segmentation algorithms (such as U-Net) may be used to identify pixels of candidate droplets.

Once the candidate droplets 616 have been identified in the image 615, as indicated by block 620 and depicted in example image 621, location identification instructions 484 direct processor 462 to carry out circle detection and screening. The example image 621 is an example of an image of a region of substrate 470 captured by microscope 440 with highlighting of the identified droplets/spots 622 of substance 22-1, 22-2 following the circle detection and screening. The circle detection and screening is described above with respect to block 520 in FIG. 10. As described above with respect to method 100, prior to circle detection and screening, noise artifacts may be removed from image 615. As indicated by block 624, location identification instructions 484 direct processor 462 to determine the centroid coordinates and radius of each of the identified circles, each of the identified droplets (spots of substance 22-1 and/or 22-2) on substrate 470 or, in some implementations, directly on stage 450. Thereafter, sensor alignment instructions 486 may direct processor 462 to utilize the centroid coordinates and radii of each of the identified circles to output control signals causing actuator 454 to sequentially locate or align each of the identified circles/spots of substance 22-1, 22-2 with optical axis or focal point 48 of single-point sensor 46 for individual sensing in accordance with sensing instructions 488.

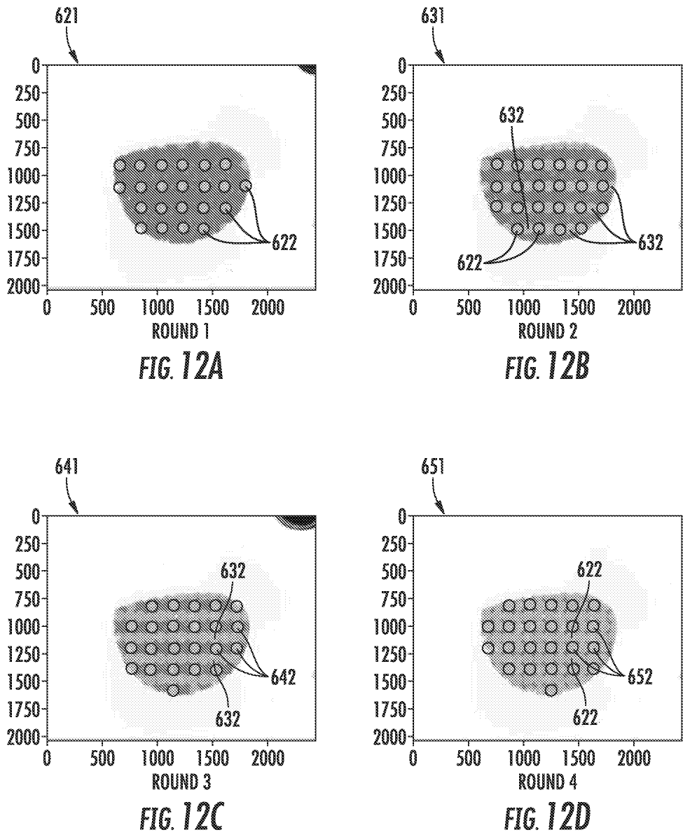

FIGS. 12A-12D are diagrams depicting example images of the same region of substrate 470 after different rounds of fluid droplet dispensing and following circle detection and screening per block 620. FIG. 12A is an enlarged view of the example image 621 described above with respect to method 600 following a first round of fluid droplet dispensing and following the circle detection and screening per block 620. The identified fluid droplets 622 have a first pattern in a region of substrate 470. The process described above with respect to method 600 may be repeated for subsequent rounds of dispensing fluid droplets onto the same region of substrate 470.

FIG. 12B depicts an example image 631 captured by microscope 440 following a second round of fluid droplet dispensing in accordance with a second pattern of dispensing and following the circle detection screening per block 620. As shown by FIG. 12B, the second pattern of fluid droplets locates fluid droplets 632 horizontally between the fluid droplets 622 of the first round of fluid dispensing. FIG. 12C depicts an example image 641 captured by microscope 440 following a third round of fluid droplet dispensing in accordance with a third pattern of dispensing and following the circle detection screening per block 620. As shown by FIG. 12C, the third pattern of fluid droplets locates fluid droplets 642 vertically between the fluid droplets 632 of the second round of fluid dispensing. FIG. 12D depicts an example image 651 captured by microscope 440 following a fourth round of fluid droplet dispensing in accordance with a fourth pattern of dispensing and following the circle detection screening per block 620. As shown by FIG. 12D, the fourth pattern of fluid droplets locates fluid droplets 652 vertically between the fluid droplets 622 of the first round of fluid dispensing. Because of the image subtraction carried out in block 614, the fluid droplets of prior dispensing rounds are digitally removed by processor 462 prior to segmentation and circle detection and screening. As a result, extremely dense patterns of fluid droplets may be formed on a relatively small region of substrate 470. The dense pattern of fluid droplets may provide multiple interrogation sites while reducing consumption of the available substrate 470. Because the multiple interrogation sites are closer to one another, positioning of each interrogation site office to and in alignment with focal point 48 of single-point sensor 46 may be more quickly performed, reducing the time consumed during the interrogation of each of the individual interrogation sites/fluid droplets.

In some implementations, the sensing of the individual droplets by single-point sensor 46 may be carried out after each individual round using the precise location coordinates of the droplets determined in block 624. In some implementations, precise coordinates of the individual droplets determined following each round pursuant to block 620 may be stored, wherein all of the droplets may be sensed at once using the stored coordinates. For example, following the identification of the precise coordinates for the droplets 652 in FIG. 12D, sensor alignment instructions 486 may direct processor 462 to output control signals sequentially positioning the focal point 48 of single-point sensor 46 opposite to each of the precise coordinates of fluid droplets 622, 632, 642 and 652 for interrogation of each of the fluid droplets.

Although the present disclosure has been described with reference to example implementations, workers skilled in the art will recognize that changes may be made in form and detail without departing from the scope of the claimed subject matter. For example, although different example implementations may have been described as including features providing benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

1. A single point sensing system comprising:
a microscope having a field of view;
a single-point sensor having a focal point;
a stage to support a substance;
an actuator to move at least one of the single-point sensor or the stage relative to one another; and
an alignment controller to:
identify a location of the substance on the stage based upon signals from the microscope; and
output sensor alignment signals to the actuator to align the location of the substance on the stage with the focal point of the single-point sensor based upon the identified location of the substance.

2. The single point sensing system of claim 1 further comprising a fluid droplet dispenser to dispense fluid containing the substance onto a deposition site of the stage, wherein the controller is further to:
output microscope alignment signals to the actuator to locate the deposition site within the field of view of the microscope.

3. The single point sensing system of claim 2, wherein the controller is to determine a location of the deposition site on the stage based upon characteristics and operation of the fluid droplet dispenser and the stage.

4. The single point sensing system of claim 2, wherein the deposition site contains a single droplet.

5. The single point sensing system of claim 4, wherein the single droplet has a maximum width of no greater than 500 microns at the deposition site.

6. The single point sensing system of claim 1, wherein the substance is contained in a sample mass having a diameter of no greater than 2 mm.

7. The single point sensing system of claim 1, where the single point sensor is selected from a group of sensors consisting of: a spectrometer, a Raman spectrometer, UV/VIS spectrometer, a colorimeter, a fluorimeter, a non-linear spectrometer, and an ultrafast laser spectrometer.

8. The single point sensing system of claim 1, wherein the actuator is to move the stage relative to the microscope and the single point sensor.

9. The single point sensing system of claim 1, wherein the signals from the microscope correspond to an image of the stage, wherein the alignment controller is to identify a circle in the image and its corresponding location on the stage, the circle corresponding to a deposited droplet, and wherein the sensor alignment signals are to align the focal point of the single point sensor with the location of the circle on the stage.

10. A single point sensing method comprising:
identifying a location of a substance on a stage based upon signals from a microscope; and
outputting sensor alignment signals to an actuator to align the location of the substance on the stage with a focal point of a single-point sensor based upon the identified location of the substance.

11. The single point sensing method of claim 10, further comprising:
dispensing a fluid droplet onto a deposition site on the stage, the fluid droplet containing the substance; and
outputting microscope alignment signals to the actuator to locate the deposition site within a field of view of the microscope.

12. The single point sensing method of claim 10, wherein the substance is deposited upon a substrate supported by the stage.

13. The single point sensing method of claim 10, wherein the substance comprises a single droplet deposited upon the stage, and wherein the control signals align the focal point of the single-point sensor with the identified location of the single droplet.

14. A non-transitory computer-readable medium containing instructions to direct a processor, the instructions comprising:
location identification instructions to direct the processor to identify a location of a substance on a stage based upon signals received from a microscope; and
sensor alignment instructions to direct the processor to output sensor alignment signals to the actuator to align the location of the substance on the stage with a focal point of a single-point sensor based upon the identified location of the substance.

15. The computer-readable medium of claim 14, wherein the instructions further comprise:
dispensing instructions to direct the processor to output fluid droplet dispensing signals to cause a fluid droplet dispenser to dispense an individual droplet of fluid onto the stage; and
microscope alignment instructions to direct the processor to output microscope alignment signals to the actuator to align a location of a deposition site of the individual fluid droplet within a field of view of the microscope.
